(19) United States
(12) Patent Application Publication
(10) Pub. No.: US 2008/0131277 A1
(43) Pub. Date: Jun. 5, 2008

(54) Ball bearing with carbon-carbon cage for gas turbine engines

(75) Inventors: Mark N. Shatz, San Diego, CA (US); Anthony C. Jones, San Diego, CA (US); Eric J. Alexander, San Diego, CA (US); Gordon F. Jewess, San Diego, CA (US)

Correspondence Address: STEPHEN GEORGE MICAN, POST OFFICE BOX 1347, WEST POINT, CA, 95255-1347, US

(73) Assignee: Hamilton Sundstrand Corporation

(21) Appl. No.: 11/633,279

(22) Filed: Dec. 4, 2006

(51) Int. Cl. F01D 25/16; F16C 33/44

(52) U.S. Cl. 415/229; 384/527

(57) ABSTRACT

A ball bearing assembly for a gas turbine engine comprises an inner race that couples to a rotor shaft; an outer race that couples to a primary static structural support; a plurality of ball elements between the inner race and the outer race; and a ball cage that comprises a carbon-carbon composite material to maintain the relative radial spacing of the ball elements between each other within the inner race and the outer race after subjection to high loads, heat generation and long-term storage.

The invention occurred with government support under Contract No.: F08635-03-C0002 awarded by the United States Air Force. The government has certain rights in the invention.

### FIELD OF THE INVENTION

The invention relates to bearings for gas turbine engines and more particularly to ball bearings for supporting a turbine shaft in a gas turbine engine.

### BACKGROUND OF THE INVENTION

Miniature gas turbine or turbojet engines, typically of 150 lb-f thrust and smaller, are often useful for single-use airborne applications such as reconnaissance drones and other unmanned air and ground launched aeronautical vehicles. The use of such an engine greatly extends the range of such vehicles in comparison to the more conventional solid fuel rocket engine.

A miniature gas turbine engine must have a relatively inexpensive manufacturing cost coupled with a high degree of starting and operational reliability when launched from air or ground systems in order to be an economically feasible extended range expendable propulsion source for such applications. The high-speed ball bearings that support the rotating turbine machine are one type of component that greatly affects mechanical performance and reliability of a miniature gas turbine engine. Reliability and efficiency of the ball bearing cage for such bearings are prime concerns for a successful expendable turbine engine. Long-term storage, excessive operational heat, or cage wear from induced loads may compromise such reliability and efficiency of the bearing cage.

Current gas turbine bearing systems employ common cage materials such as silver-plated stainless steel, brass or even poly-ether-ether-keytone (PEEK). These common materials typically are not able to handle the high loads, heat generation and long-term storage typical of single use systems, and if used in practice may increase the potential of an operational failure. Accordingly, it is desirable to utilise ball bearings with an uncomplicated and inexpensive cage material that can withstand the high loads, heat generation and long-term storage typical of single use systems for supporting the rotating turbine machine to achieve a successful miniature gas turbine engine for such expendable aeronautical applications.

### SUMMARY OF THE INVENTION

In one embodiment, the invention comprises an improved ball bearing assembly that utilises a carbon-carbon ball cage for its ball elements to maintain the relative radial spacing of the ball elements between each other after the ball bearing assembly is subjected to high loads, heat generation and long-term storage.

Generally, the invention comprises a ball bearing assembly for a gas turbine engine, comprising: an inner race that couples to a rotor shaft; an outer race that couples to a primary static structural support; a plurality of ball elements between the inner race and the outer race; and a ball cage that comprises a carbon-carbon composite material to maintain the relative radial spacing of the ball elements between each other within the inner race and the outer race after the ball bearing assembly is subjected to high loads, heat generation and long-term storage.

### DESCRIPTION OF THE DRAWINGS

FIG. 1 is a side view of an expendable aeronautical vehicle that is suitable for incorporating at least one embodiment of the invention.

FIG. 2 is a cut-away side view of a miniature turbine engine for the expendable aeronautical vehicle shown in FIG. 1 that is suitable for incorporating at least one embodiment of the invention.

FIG. 3 is a cut-away side view of a bearing assembly according to a possible embodiment of the invention.

FIG. 4 is a top view of a bearing assembly according to the possible embodiment of the invention shown in FIG. 3.

### DETAILED DESCRIPTION OF THE INVENTION

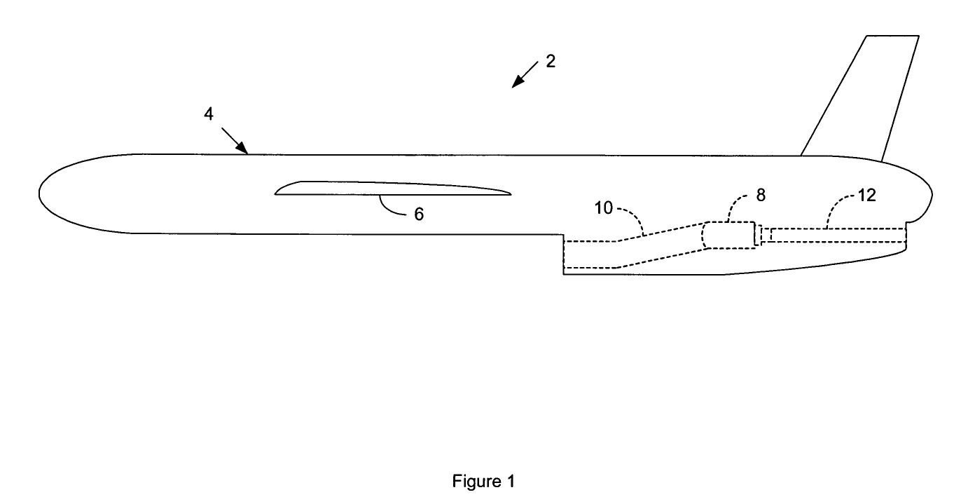

FIG. 1 is a side view of an expendable aeronautical vehicle 2 that is suitable for incorporating at least one embodiment of the invention. The vehicle 2 comprises an airframe 4 with one or more aerodynamic surfaces 6. The vehicle 2 also comprises a propulsion engine 8, typically of the gas turbine or turbojet type. The engine 8 mounts within or to the vehicle 2. In FIG. 1, for purposes of illustration the engine 8 mounts within the vehicle 2, as shown in dashed line. An intake 10, shown in dashed line, supplies ambient air to the engine 8. An exhaust pipe 12, shown in dashed line, exhausts the thrust of the engine 8 to propel the vehicle 2.

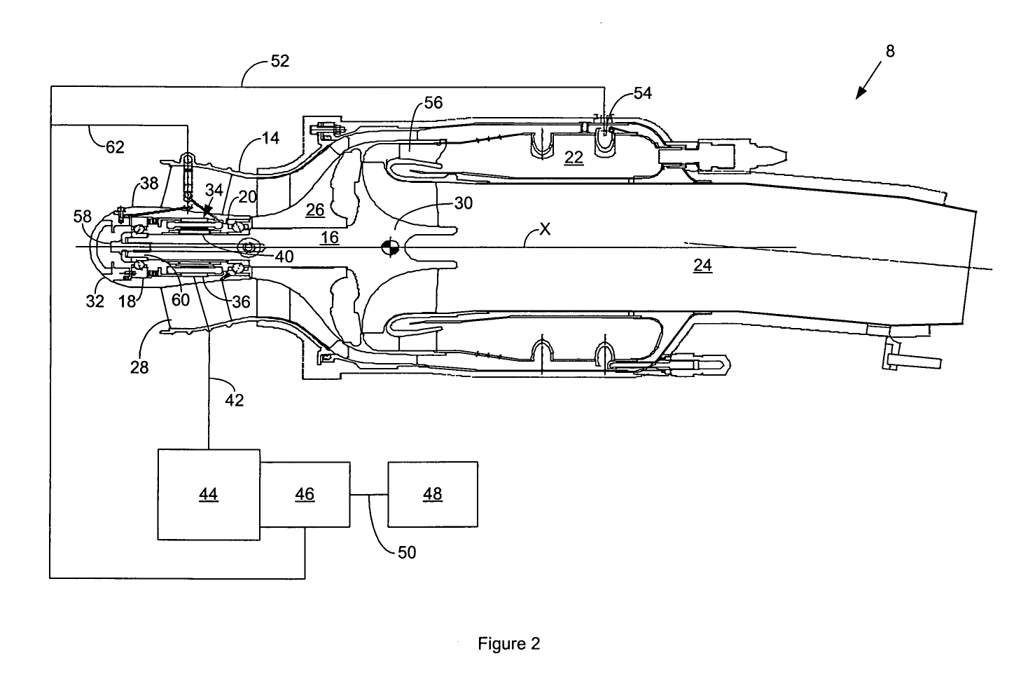

FIG. 2 is a cut-away side view of a miniature turbine engine 8 for the expendable aeronautical vehicle shown in FIG. 1 that is suitable for incorporating the invention. The miniature gas turbine engine 8 generally comprises a housing 14, a rotor shaft 16 supported by a forward bearing 18 and an aft bearing 20, a generally annular combustion chamber 22 and an exhaust pipe 24. The forward bearing 18 and the aft bearing 20 allow the rotor shaft 16 to rotate about a longitudinal axis X. The forward bearing 19 and the aft bearing 20 are both of the ball bearing type.

A multi-bladed compressor wheel 26 mounted on the rotor shaft 16 faces forward toward an intake 28 and a multi-bladed turbine wheel 30 mounted on the rotor shaft 16 faces rearward toward the exhaust pipe 24. The forward bearing 18 and the aft bearing 20 support the rotor shaft 16 to extend it at least partially into a forward cover 32. The forward cover 32 is preferably the forward-most portion of the engine 8 and defines an aerodynamically contoured shape. The intake 28 generally surrounds the forward cover 32 to facilitate airflow.

A permanent magnet generator (PMG) 34 preferably mounts on the rotor shaft 16 between the forward bearing 18 and the aft bearing 20 to generate electrical power for the engine 8 and other accessories. The PMG 34 comprises a stator 36 that mounts to the housing 14 by way of a housing inner support 38 and a rotor 40 mounted on the rotor shaft 16. An electrical power line 42 transfers electrical power from the PMG 34 to an electrical power system 44.

A fuel pump 46 to pump fuel from a fuel source 48 by way of a fuel source line 50 pumps fuel to the annular combustion chamber 22 by way of a pump supply line 52 through a fuel manifold 54. The electrical power system 44 preferably drives the fuel pump 46, although alternatively the turbine wheel 30 could drive the fuel pump 46 by way of a suitable transmission (not shown) coupled to the rotor shaft 16. The fuel burns at high temperatures within the combustor chamber 22 to generate expanding exhaust gases that flow through a turbine nozzle 56, the turbine wheel 30 and the exhaust pipe 24 thereby driving the turbine wheel 30 and generating a high velocity thrust out of the exhaust pipe 24.

A fastener 58, such as a threaded rotor nut or bolt, may conveniently couple to a mating end portion 60 of the rotor shaft 16, such as a threaded stud or aperture, to retain the rotor shaft 16 within the forward bearing 18 and the aft bearing 20. The housing inner support 38 conveniently mounts the forward bearing 18 and the aft bearing 20 to the housing 14.

The housing 14 provides the primary static structural support for rotation of the rotor shaft 16 and the hereinbefore-described rotational components mounted on it. The fastener 58 extends at least partially within the forward cover 32. The forward cover 32 mounts to the housing 14. Removal of the forward cover 32 facilitates assembly and disassembly by providing access to the fastener 58.

The housing 14 includes a lubrication line 62 supplied by a lubrication source that supplies suitable bearing lubricant, such as fuel, oil or a mixture thereof to the bearings 18 and 20. The lubrication source may conveniently be the fuel source 48, in which case the lubrication line 62 may couple to the fuel source line 50. The lubrication line 62 may conveniently supply a plurality radial lubricant passages (not shown) arranged about each of the bearings 18 and 20.

In any case, the lubricant delivery preferably sprays lubricant onto the bearings 18 and 20. Such lubrication delivery still further improves reliable operation. Furthermore, the cooling airflow that passes through the forward cover 32 propagates lubricant that collects aft of the forward bearing 18 toward the aft bearing 20 and into the combustion chamber 22. Using a fuel or a fuel oil mixture as the lubricant maintains engine efficiency, since the lubricant ultimately propagates into the combustion system 22 for combustion and thrust generation.

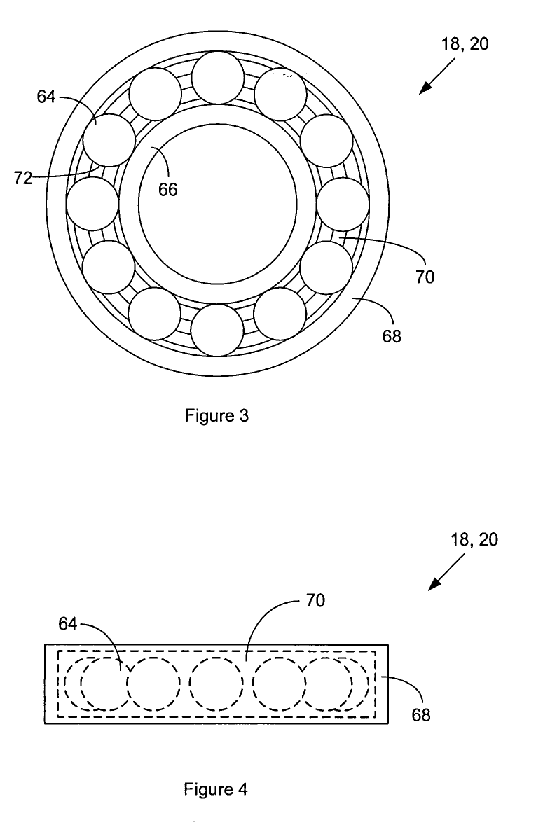

FIG. 3 is a cut-away side view of the bearings 18 and 20 according to a possible embodiment of the invention. FIG. 4 is a top view of the bearings 18 and 20 according to the possible embodiment of the invention shown in FIG. 3. Each bearing 18 and 20 has a plurality of ball elements 64 arranged radially between an inner race 66 and an outer race 68. A ball cage 70 comprises a plurality of apertures 72 arranged around its periphery that each retain a respective ball element 64 and serve to maintain the relative radial spacing of the ball elements 64 between each other within the inner race 66 and the outer race 68. According to one possible embodiment of the invention, the ball cage 70 may comprise a carbon-carbon or reinforced carbon-carbon (RCC) composite material.

Carbon-carbon or RCC material is a composite of carbon fibre, usually made from pitch, rayon, or poly-acrylo-nitrile (PAN), in a carbon-dominated matrix. Fabrication of such materials generally uses a high-content carbon resin as the initial matrix subjected to high heat to drive off the non-carbon elements. The carbon-carbon composite material may be carbonised or graphitised, depending on the temperature of the heating process. It is lightweight, highly heat-resistant, thermal-shock-resistant, and malleable for shaping as necessary. Allcomp Inc., of City of Industry, California manufactures a suitable carbon-carbon or RCC material for this purpose.

Relative positional terms as hereinbefore described, such as “forward”, “aft”, “upper”, “lower”, “above”, “below”, and the like are with reference to the normal operational attitude and should not be considered otherwise limiting.

The described embodiment of the invention is only an illustrative implementation of the invention wherein changes and substitutions of the various parts and arrangement thereof are within the scope of the invention as set forth in the attached claims.

The claimed invention is:

1. A ball bearing assembly for a gas turbine engine, comprising:
an inner race that couples to a rotor shaft;
an outer race that couples to a primary static structural support;
a plurality of ball elements between the inner race and the outer race; and
a ball cage that comprises a carbon-carbon composite material to maintain the relative radial spacing of the ball elements between each other within the inner race and the outer race after subjection to high loads, heat generation and long-term storage.

2. The ball bearing assembly of claim 1, wherein the carbon-carbon composite material comprises carbon fibre in a carbon-dominated matrix.

3. The ball bearing assembly of claim 2, wherein the carbon fibre is a carbon fibre selected from the group of pitch, rayon, and poly-acrylo-nitrile (PAN) fibres.

4. The ball bearing assembly of claim 2, wherein the carbon-dominated matrix comprises a high-content carbon resin.

5. The ball bearing assembly of claim 1, wherein the carbon-carbon composite material is carbonised.

6. The ball bearing assembly of claim 1, wherein the carbon-carbon composite material is graphitised.

7. The ball bearing assembly of claim 1, further comprising a sprayed lubricant.

8. The ball bearing assembly of claim 7, wherein the lubricant comprises fuel for the engine.

9. The ball bearing assembly of claim 7, wherein the lubricant comprises oil.

10. The ball bearing assembly of claim 7, wherein the lubricant comprises a mixture of fuel for the engine and oil.

11. A bearing system for a gas turbine engine, comprising:
a housing for the engine that serves as a primary static structural support;
a rotor shaft for mounting rotational components of the engine;
at least two bearings for supporting the rotor shaft within the housing, each bearing comprising an inner race that couples to the rotor shaft, an outer race that couples to a housing, a plurality of ball elements between the inner race and the outer race and a ball cage that comprises a carbon-carbon composite material to maintain the relative radial spacing of the ball elements between each other within the inner race and the outer race; and
a lubrication system that sprays lubricant onto each of the bearings.

12. The bearing system of claim 11, wherein the lubricant comprises fuel for the engine.

13. The bearing system of claim 11, wherein the lubricant comprises oil.

14. The bearing system of claim 11, wherein the lubricant comprises a mixture of fuel for the engine and oil.

15. The bearing system of claim 11, wherein air flow through the engine propagates sprayed lubricant from a forward one of the bearings to at least one aft bearing an into a combustion chamber for the engine.

16. The bearing system of claim 11, wherein the lubrication system further comprises a plurality of radial lubrication passages arranged about each of the bearings.

17. A gas turbine engine comprising:
a housing for the engine that serves as a primary static structural support;
a rotor shaft;
a compressor wheel mounted on the rotor shaft for compressing air;
a combustion chamber for combusting the compressed air with fuel to generate expanding exhaust gas;
a turbine wheel mounted on the rotor shaft driven by the expanding exhaust gas;
at least two bearings for supporting the rotor shaft within the housing, each bearing comprising an inner race that couples to the rotor shaft, an outer race that couples to a housing, a plurality of ball elements between the inner race and the outer race and a ball cage that comprises a carbon-carbon composite material to maintain the relative radial spacing of the ball elements between each other within the inner race and the outer race; and
a lubrication system that sprays lubricant onto each of the bearings.

18. The engine of claim 17, wherein the lubricant comprises fuel for the engine.

19. The engine of claim 17, wherein air flow through the engine propagates sprayed lubricant from a forward one of the bearings to at least one aft bearing an into a combustion chamber for the engine.

20. The engine of claim 17, wherein the lubrication system further comprises a plurality of radial lubrication passages arranged about each of the bearings.
